(19) United States
(12) Patent Application Publication
(10) Pub. No.: US 2023/0021011 A1
(43) Pub. Date: Jan. 19, 2023

(54) PRESS ASSEMBLY FOR A GRIDDLE

(71) Applicant: Steak n Shake Enterprises, Inc., Indianapolis, IN (US)

(72) Inventors: Sardar Biglari, Indianapolis, IN (US); Paul LEDGARD, Indianapolis, IN (US)

(73) Assignee: Steak n Shake Enterprises, Inc., Indianapolis, IN (US)

(21) Appl. No.: 17/946,744

(22) Filed: Sep. 16, 2022

Related U.S. Application Data
(62) Division of application No. 16/659,245, filed on Oct. 21, 2019.

(51) Int. Cl. A47J 43/18; A47J 37/06; A22C 7/00; A23L 5/10

(52) U.S. Cl. CPC A47J 43/18; A47J 37/067; A22C 7/0076; A23L 5/15; A23V 2002/00

(57) ABSTRACT

Disclosed herein is a press mechanism for a griddle to mold a steak burger puck into a formed steak burger patty. The press mechanism can include an arm connected to a hinge. The hinge can be attached to a griddle surface. The platen can be connected to the arm and can include a concave surface to receive a steak burger puck. A platen heater can be connected to the platen to heat the platen to an operating temperature.

This application is a divisional of U.S. application Ser. No. 16/659,245, filed Oct. 21, 2019. The present disclosure relates to food preparation implements, more specifically a food preparation assembly for molding food patties.

### BACKGROUND

### Field

### Background

Numerous cooking appliances with heated cooking surfaces are utilized in the food service industry. These devices may be formed as griddles or stoves, for example, having heated cooktops upon which food to be cooked is placed. These devices transfer thermal energy from the cooktop to the bottom of the food thereon. Once the first surface of the food is sufficiently cooked, the food may be flipped or otherwise repositioned so that different surfaces of the food are in direct contact with the cooktop.

In the food service industry, food preparation implements are commonly used with cooking appliances to sear food items, such as hamburger patties, against the cooking surface. For example, typical food preparation implements include a spatula or a press plate that are used to apply a downward force against the food item. Food preparation implements, however, typically include a flat surface to abut against food patties on the cooking surface, which simply compresses the food patty uniformly. Consequently, a chef cannot reconfigure the shape of the entire food patty in a single motion. Instead, the chef must apply the food implement several times against different locations on the food patty, thereby rendering the cooking process more complicated and time consuming.

### BRIEF SUMMARY

The present disclosure includes various embodiments of a press mechanism for a griddle. The press mechanism can include an arm connected to a hinge, the hinge being attached to a griddle surface; a platen connected to the arm, the platen comprising a concave surface to receive a steak burger puck; and a platen heater connected to the platen to heat the platen to an operating temperature. The operating temperature can be less than approximately 200 degrees Fahrenheit.

The press mechanism operating temperature can be approximately 140 degrees Fahrenheit to approximately 165 degrees Fahrenheit. The press mechanism operating temperature can be approximately 140 degrees Fahrenheit to approximately 145 degrees Fahrenheit.

The press mechanism concave surface can have a depth of approximately ¼ inch to approximately 3/16 inch and a diameter of approximately 4 inches to approximately 4.5 inches

The press mechanism arm and platen can move from an open position where the platen is positioned at a first height above the griddle surface to a press position to mold the steak burger puck into a formed steak burger patty, and the hinge can bias the arm and platen upward from the press position. The press mechanism can include a lock to hold the arm and platen in the press position. The press mechanism can include a release timer to release the lock after a press time. After the lock is released, the arm and platen can move from the press position to a released position such that the platen does not contact the formed steak burger patty in the released position.

In another aspect, a griddle can include a cooktop including a target location indicium for placement of a food patty; a press mechanism; and a platen heater connected to the platen to heat the platen to an operating temperature of less than approximately 200 degrees Fahrenheit. The press mechanism can include an arm connected to a hinge and the hinge can be attached to a griddle surface. The press mechanism can include a platen connected to the arm and the platen can include a concave surface to receive a steak burger puck, such that the target location indicium aligns along a vertical axis with an apex of the concave surface.

The griddle press mechanism can have an operating temperature of approximately 140 degrees Fahrenheit to approximately 145 degrees Fahrenheit. The griddle press mechanism can have a concave surface with a depth of approximately ¼ inch to approximately 3/16 inch and a diameter of approximately 4 inches to approximately 4.5 inches. The griddle press mechanism arm and platen can move from an open position where the platen is positioned at a first height above the griddle surface to a press position to mold the steak burger puck into a formed steak burger patty. The hinge can bias the arm and platen upward from the press position.

The griddle can include a lock to hold the arm and platen in the press position. The griddle can include a release timer to release the lock after a press time. After the lock is released, the arm and platen can move from the press position to a released position, such that the platen does not contact the formed steak burger patty in the released position. The platen can be approximately 3 inches above the cooktop in the released position.

In a further aspect, a method for cooking a steak burger can include placing a steak burger puck on a target location indicium on a cook top and lowering a press mechanism to mold the steak burger puck into a formed steak burger patty. The press mechanism can include an arm connected to a hinge, the hinge being attached to the cook top, and a platen connected to the arm. The platen can also include a concave surface to receive the steak burger puck. The method can include heating the platen to a platen temperature of less than approximately 200 degrees Fahrenheit; raising the press mechanism away from the formed steak burger patty; flipping the formed steak burger patty such that a non-cooked side of the formed steak burger patty contacts the cook top; and removing the formed steak burger patty from the cook top approximately 20 seconds to approximately 25 seconds after flipping the formed steak burger patty.

The method can include placing a second steak burger puck on a second target location indicium on the cook top. The lowering the press mechanism can include molding the second steak burger puck into a second formed steak burger patty. The method can include flipping the second formed steak burger patty such that a non-cooked side of the second formed steak burger patty contacts the cook top; and removing the formed steak burger patty from the cook top approximately 20 seconds to approximately 25 seconds after flipping the formed steak burger patty. The steak burger puck can include approximately 80% sirloin. The target location indicium can be stamped or engraved into the cooktop. The heating the platen to a platen temperature of less than approximately 200 degrees Fahrenheit can include heating the platen to a range of approximately 140 degrees to approximately 145 degrees.

The method can include locking the press mechanism in a press position to mold the steak burger puck into the formed steak burger patty; and automatically releasing the press mechanism from the press position after a press time.

### BRIEF DESCRIPTION OF THE DRAWINGS

The accompanying drawings, which are incorporated herein and form a part of the specification, illustrate the embodiments and, together with the description, further serve to explain the principles of the embodiments and to enable a person skilled in the relevant art(s) to make and use the embodiments.

FIG. 1 is a perspective view of a cooking assembly comprising a griddle and a press assembly coupled to the griddle according to an embodiment.

FIG. 2 is a perspective view of a griddle (with press assembly) according to an embodiment.

FIG. 3 is a side schematic view of a platen and a leverage mechanism of a press assembly according to an embodiment.

FIG. 4 is a bottom schematic view of a platen and a leverage mechanism of a press assembly according to an embodiment.

FIG. 5 is a side cross-section schematic view of a cooking assembly comprising a griddle and a press assembly, in which a platen of the press assembly is set in a press position according to an embodiment.

FIG. 6 is a side schematic view of a press assembly with a platen coupled to a griddle showing various operation positions of the platen according to an embodiment.

FIG. 7 is a flow chart showing process steps for cooking a steak burger patty according to an embodiment.

FIG. 8 shows a schematic block diagram of an exemplary computer system in which embodiments may be implemented

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

A sirloin steak burger can be approximately 80% sirloin and approximately 20% choice cuts of meat. A sirloin steak burger is generally leaner than a regular beef hamburger patty and can dry out if not cooked properly, resulting in an undesirable food item.

A food patty, and in particular a steak burger patty, can be cooked in a manual process that results in a cooked patty with a thick juicy center and thin crispy, lacey edges. In the case of a steak burger patty, this manual process can include placing a fresh, raw steak burger puck on the grill to sear a first side of the raw steak burger puck. The fresh, raw steak burger puck can weigh approximately 2 ounces to approximately 2.5 ounces, such as approximately 2.2 ounces, can be approximately 2.5 inches to approximately 3 inches in diameter, and can be approximately 1 inch thick. The steak burger puck can then be flipped and a chef can begin a smashing process to thin the puck into a formed steak burger patty. For example, the chef can press a spatula downward into the steak burger puck from the right side, from the left side, from the top side, and from the bottom side to form. The formed steak burger patty can be approximately 4 inches in diameter to approximately 4.5 inches in diameter and can have a center thickness of approximately ¼ inch to approximately 3/16 inch. The formed steak burger patty can also taper downward from the center so that the edges of the steak burger patty are much thinner than the center. After smashing and cooking the steak burger puck for a first cook time, for example approximately 70 seconds, the chef can flip the formed steak burger patty and then cook the steak burger patty for a second cook time, for example approximately 20 seconds. Thus, a manual process to form and cook a steak burger patty can require approximately six steps in approximately 90 seconds.

In a restaurant setting, a chef is required to replicate this manual process in a fast repeatable manner to deliver consistent, tasty steak burgers. However, it is difficult to deliver a consistent product at a fast pace because the steak burger patties can easily dry out or become overcooked if not cooked by a trained, experienced chef.

While various food preparatory implements have been used to handle food patties being heated by a cooking appliance, food preparatory instruments, e.g., spatulas and press plates, typically compress food patties uniformly, rendering a finished food patty with a uniform thickness. Food patties having a uniform thickness, however, tend to lack the combination of a juicy center and crispy, lacey edges, making the food patty less tasty, such as is desirable for a cooked steak burger patty.

In addition, portions of food patties tend to adhere to the smashing surface of the food preparation implement after the cooking process, rendering the food preparation implement unsanitary for the next cooking process. Accordingly, a chef must clean the contacting surface of the food preparation implement thoroughly after each cooking process to avoid contaminating food patties cooked in subsequent sessions. Cleaning the food preparation implements thoroughly after each session extends the time needed to prepare and cook a large number of food patties.

Thus, there is a need for a food preparation implement that can quickly and repeatedly mold a food patty into a formed shape with a variable thickness and prevent portions of the of the food patty from adhering to the surface of the implement, while expediting the cooking process of the food patty.

According to various embodiments described herein, the cooking assembly of the present disclosure may overcome one or more of the deficiencies noted above by comprising a griddle with a cooking surface that includes one or more target locations to receive a steak burger patty and further comprising a press assembly configured to mold the patties to a predetermined shape while being heated by the cooking surface of the griddle. The press assembly may include a platen with a bottom mold shell that may be set to a press position, wherein the bottom mold shell is configured to apply force against the steak burger patty non-uniformly such that the thickness of the molded steak burger patty varies from a central portion to a peripheral portion of the patty. The press assembly may further include a heater configured to raise a temperature of the bottom mold shell to an operating temperature that does not further cook the steak burger patty, but prevents portions of the steak burger patty from adhering to the bottom mold shell and/or prevents bacterial growth. The press assembly may further include a lock configured to lock the platen at the press position and a leverage mechanism configured to bias the platen from the press portion to a release position once the platen is released from the lock.

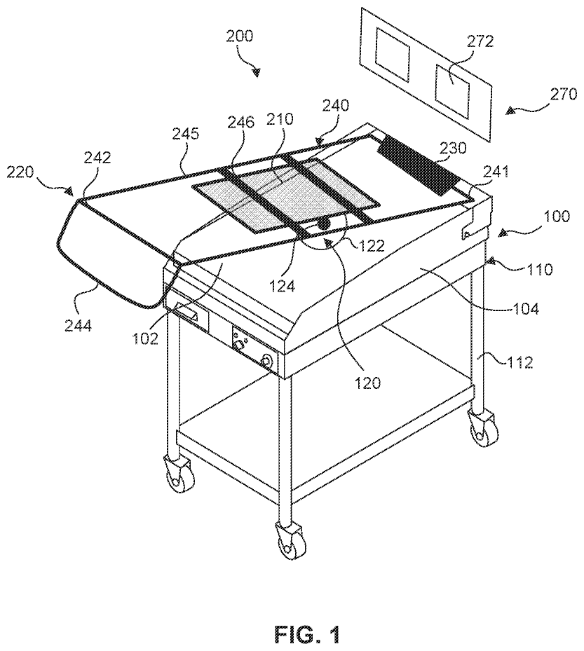

Embodiments will now be described in more detail with reference to the figures. With reference to FIG. 1, for example, a cooking assembly 10 may comprise a griddle 100 for cooking food items (e.g., steak-burger patties) and a press assembly 200 operatively coupled to the griddle 100 for molding the food items into a predetermined shape. In some embodiments, griddle 100 may comprise a cooking surface 102 comprised of a conductive material (e.g., chrome steel, stainless steel, aluminum, etc.) that is configured to receive one or more food items (e.g., steak-burger patties). In some embodiments, griddle 100 may comprise a heat-generating component (e.g., gas burner with an igniter, resistive heating coils with an electric power supply, charcoals or coal supply with lighter, etc.) configured to generate and apply heat to the cooking surface 102. In some embodiments, griddle 100 may comprise a shield wall 104 erected around the cooking surface 102 to capture any heated fluids deflected from the cooking surface 102. In some embodiments, griddle 100 may comprise a base 110 supporting the cooking surface 102 and including a plurality of legs 112 to hold the cook surface 102 at a predetermined height.

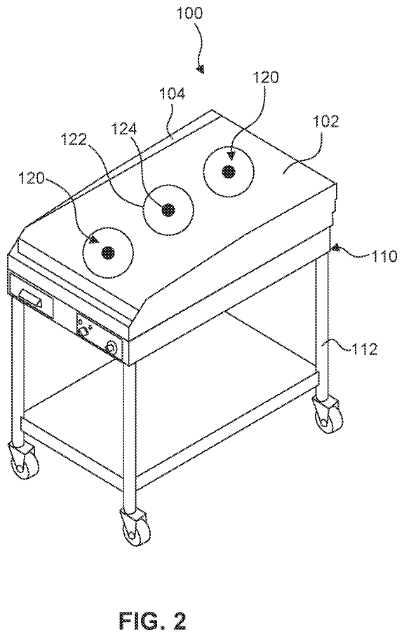

In some embodiments, as shown, for example, in FIG. 2, cooking surface 102 may comprise one or more target locations 120 for strategically placing the food items on the cooking surface 102. In certain embodiments, target locations 120 may comprise a circular-shaped indicium 122. In some embodiments, the circular-shaped indicium 122 may include a diameter that corresponds to the transverse dimensions of a fresh, raw steak burger puck. For example, the circular-shaped indicium 122 can have a diameter of approximately 2.5 inches to approximately 3 inches. In another aspect, circular-shaped indicium 122 can have a diameter of the target diameter for a formed food item. For example, the circular-shaped indicium 122 can have a diameter of approximately 4 inches to approximately 4.5 inches. In some embodiments, the circular-shaped indicium 122 may be formed by stamping or engraving the cooking surface 102. In certain embodiments, target locations 120 may comprise a center indicium 124 disposed in the center of the circular-shaped indicium 122. In an aspect, the center indicium 124 can be stamped or engraved onto the cooking surface 102. In an aspect, target locations 120 can include center indicium 124 without circular-shaped indicium 122. In another aspect, center indicium 124 can be a hole that is configured to input steam from a steam source against the food item.

In various embodiments, as shown, for example, in FIGS. 1, 3, and 4, the press assembly 200 may comprise a platen 210 configured to mold food items placed on target locations 120 of cooking surface 102 into a predetermined final shape and a leverage mechanism 220 coupled to griddle 100 and configured to move platen 210 to one or more positions relative to cooking surface 102. Leverage mechanism 220 may comprise a hinge 230, an arm 240 coupled to platen 210 and rotatably coupled to hinge 230, and a handle 244 coupled to arm 240. In an aspect, platen 210 can mold one food item at a time. In another aspect, platen 210 can mold multiple food items simultaneously, for example two, three, four, or greater than four food items.

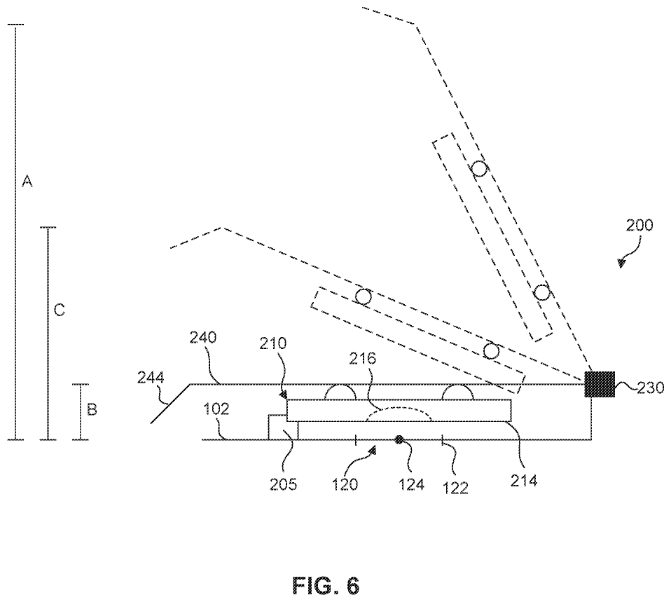

In some embodiments, as shown, for example, in FIG. 6, leverage mechanism 220 may be configured to move platen 210 to an open position, wherein at least a portion of platen 210 is spatially separated from cooking surface 102 by a first clearance A so that a chef may selectively access cooking surface 102 to place and remove food items from target locations 120. In some embodiments, as shown, for example, in FIG. 6, leverage mechanism 220 may be configured to move platen 210 to a press position, wherein at least a portion of platen 210 is spatially separated from cooking surface 102 by a second clearance B that is less than first clearance A. At the press position, platen 210 is configured to press food items against target locations 120 of cooking surface 102.

In some embodiments, press assembly 200 may comprise a lock 205 configured to releasably retain platen 210 at the press position. In some embodiments, lock 205 may be disposed on the grill surface 102 and be configured to receive a portion of platen 210. In some embodiments, lock 205 may be disposed on any portion of griddle 100 and be configured to receive a portion of leverage mechanism 220 to retain platen 210 at the press position. In some embodiments, lock 205 may comprise a latch to retain platen 210 at the press position. In some embodiments, lock 205 may comprise an electromagnet to retain platen 210 at the press position. In an aspect, lock 205 can provide feedback to a chef to indicate that press assembly 200 is appropriately locked. For example, lock 205 can provide tactile, auditory, and/or visual feedback to the chef to indicate that press assembly 200 is appropriately locked.

In an aspect, after release, lock 205 can provide feedback to a chef to indicate that press assembly 200 is released. For example, lock 205 can provide tactile, auditory, and/or visual feedback to the chef to indicate that press assembly 200 is released. In an aspect, press assembly 200 can move to a released position to indicate to a chef that press assembly 200 is released.

In some embodiments, press assembly 200 may comprise a timer controller 270 operatively coupled to lock 205 and configured to selectively actuate lock 205 between a lock state, wherein lock 205 retains platen 210 at the press position, and a release state, wherein lock 205 is decoupled from platen 210 or leverage mechanism 220 connected to platen 210. In some embodiments, timer controller 270 may be configured to maintain lock 205 at the lock state for a predetermined period of time inputted from a user. For example, timer controller 270 may be configured to maintain lock 205 at the lock state for approximately 5 seconds.

In some embodiments, timer controller 270 may comprise a display 272 indicating the period of time that platen 210 is retained by lock 205. In some embodiments, timer unit 270 may comprise an input device (e.g., touch pad, key pad, etc.) that allows a user to set the period of time for lock 205 to retain platen 210 at the press position. In some embodiments, timer unit 270 may comprise any type of computer system, such as embodiments (e.g., computer system 400) described herein.

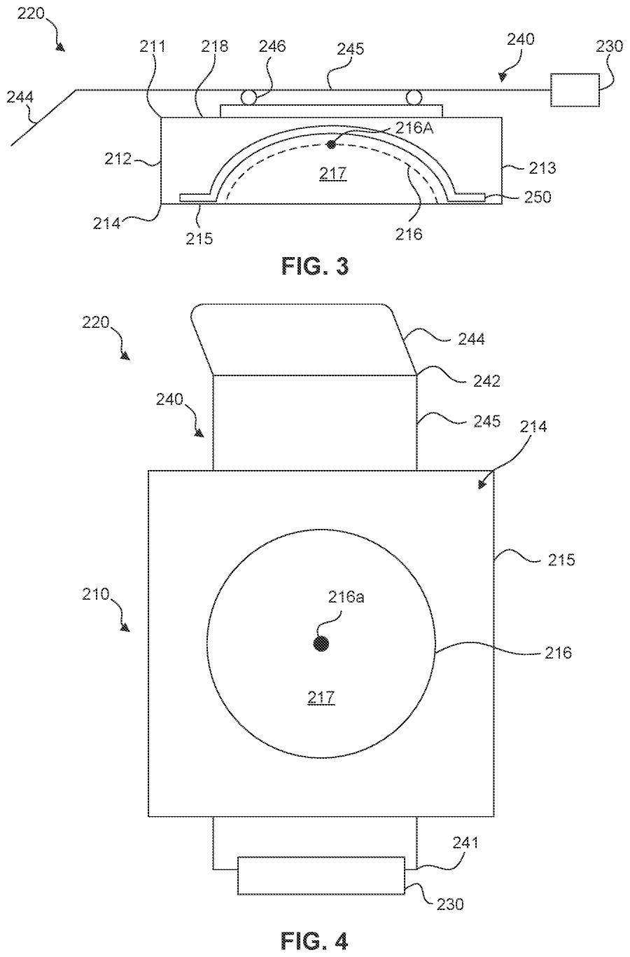

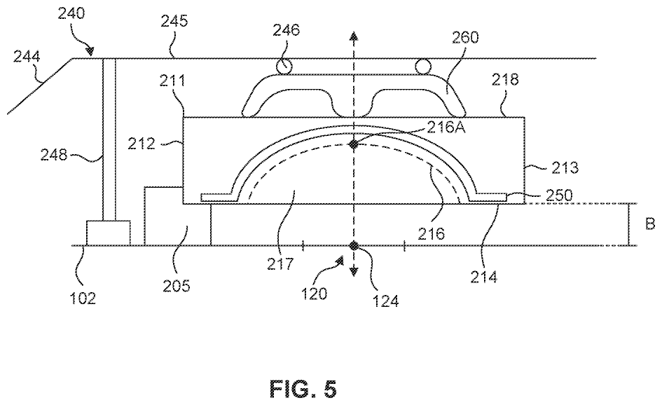

Referring to FIGS. 3 and 4, in some embodiments, platen 210 may comprise a body 211 having a front end 212, a rear end 213, and a bottom mold shell 214 extending from front end 212 to rear end 213. In some embodiments, bottom mold shell 214 may be configured to face cooking surface 102 when platen 210 is set in the press position. In some embodiments, bottom mold shell 214 may comprise a flat surface 215 and one or more curved, indented surfaces 216, in which each indented surface 216 defines a concave-shaped cavity 217 extending into body 211 of platen 210. In some embodiments, as shown, for example, in FIG. 5, one or more indented surfaces 216 may be disposed along bottom mold shell 214 such that each cavity 217 aligns with a corresponding target location 120 of cooking surface 102 when platen 210 is set in the press position. For example, platen 210 can include two, three, four, or greater than four indented surfaces 216 to mold multiple food items simultaneously.

In some embodiments, an apex 216A of the curve defined by indented surface 216 may be aligned with center indicium 124 along a vertical axis when platen 210 is in the press position. In an aspect, when platen 210 is in the press position, apex 216A can be spaced approximately ¼ inch to approximately 3/16 inch above cooking surface 102.

In some embodiments, flat surface 215 of bottom mold shell 214 may be separated from cooking surface 102 by second clearance B when platen 210 is set in the press position. In some embodiments, second clearance B is set at a dimension less than the height of the food item so that bottom mold shell 214 presses against the upper side of the food item when platen 210 is moving toward the press position. In some embodiments, each cavity 217 of bottom mold shell 214 may be configured to receive a respective food item placed at a corresponding target location 120 of a cooking surface 102 when platen 210 is set in the press position. In some embodiments, each indented surface 216 may be configured to engage the respective food item when platen 210 is set in the press position, such that bottom mold shell 214 molds the shape of the food item to a final shape defined by the cavity 217. In certain embodiments, the shape of cavity 217 may be set to a predetermined shape that allows bottom mold shell 214 to apply a first amount of pressure against a central portion of the food item and a second amount of pressure against a peripheral portion of the food item that is greater than the first amount of force during a pressing motion.

In some embodiments, after setting platen 210 to the press position, the molded food item may comprise a final shape, in which a central portion of the molded food item comprises a first height and a peripheral portion of the molded food item comprises a second height that is less than the first height. In some embodiments, the first height may range from 0.2 to 0.3 inches, such as approximately 0.25 inches, and the second height may range from 0.15 to 0.2 inches, such as 0.19 inches. In some embodiments, after setting platen 210 to the press position, the molded food item may comprise a final shape that includes a substantially circular contour defining a diameter ranging from approximately 3.5 inches to approximately 5.5 inches, such as approximately 4 inches to approximately 4.5 inches. In some embodiments, after setting platen 210 to the press position, the molded food item may comprise a final shape that includes a substantially circular contour defining a diameter of about 4.5 inches. In some embodiments, the molded food item may comprise a steak-burger meat patty that includes crispy and lacey edges and a juicy center.

In some embodiments, bottom mold shell 214 may define a plurality of cavities 217 (e.g., two, three, four, or more than four) aligned in a row so that platen 210 may simultaneously mold multiple food items in one pressing motion. In some embodiments, press assembly 200 may comprise multiple platens 210 aligned in a lateral direction along the cooking surface 102, in which each platen 210 comprises a bottom mold shell 214 defining a plurality of cavities 217 aligned in a longitudinal direction, thereby increasing the capacity of food items being molded in one pressing motion. In some embodiments, multiple press assemblies 200 can be aligned in a lateral direction along the cooking surface 102, in which each press assembly 200 and platen 210 comprises a bottom mold shell 214 defining a plurality of cavities 217 aligned in a longitudinal direction, thereby increasing the capacity of food items being molded in one pressing motion.

In some embodiments, as shown, for example, in FIGS. 3 and 5, platen 210 comprises a heater 250 configured to elevate the temperature of the bottom mold shell 214 to an operating temperature. In certain embodiments, the operating temperature may be set at a temperature that does not cook the food item, i.e., apply a sufficient amount of heat to transform the food item to an edible state. In certain embodiments, the operating temperature may be set at a temperature that applies a sufficient amount of heat to prevent food items from attracting or sticking to the bottom mold shell 214. In another aspect, the operating temperature may be set at a temperature that applies a sufficient amount of heat to prevent bacterial growth and foodborne illness. In some embodiments, the operating temperature may range from about 110° F. to about 200° F., such as about 140° F. to about 165° F., such as about 140° F. to about 145° F. In an aspect, the operating temperature may be less than approximately 200° F. Heating platen 210 to the operating temperature reduces the likelihood of the food item (e.g., steak burger patty) sticking to bottom mold shell 214 after the completion of the molding process, while also not heating the food item sufficiently to interfere with the cooking process.

In some embodiments, as shown in FIGS. 1, 3, and 4, leverage mechanism 220 may comprise a hinge 230, an arm 240 coupled to platen 210 and rotatably coupled to hinge 230, and a handle 244 coupled to arm 240. In some embodiments, hinge 230 may be coupled to a portion of shield wall 104 disposed along a back end of griddle 100. In some embodiments, arm 240 may include a first end 241 rotatably coupled to hinge 230 and a second end 242 coupled to a handle 244. In some embodiments, arm 240 may comprise a pair of rails 245 extending from first end 241 to second end 242 and one or more transverse struts 246 extending between pair of rails 245. In some embodiments, at least one transverse strut 246 is coupled to an upper surface 218 of platen 210, whereby platen 210 extends between pair of rails 245. In some embodiments, leverage mechanism may comprise one or more supporting members 260 disposed along upper surface 218 of platen 210 and connected to one or more struts 246 to promote a secured connection between arm 240 and platen 210.

In certain embodiments, hinge 230 may comprise a bracket mounted to shield wall 104 and a set of bearings. In some embodiments, first end 241 of arm 240 may be rotatably received in the bearings of hinge 230 so that arm 240 may pivot about a pivot axis defined by first end 241. In some embodiments, arm 240 may comprise a stopper 248 projecting from at least one of rails 245 and struts 246 and configured to abut against the cooking surface 102 when platen 210 reaches the press position. In some embodiments, stopper 248 may project beyond bottom mold shell 214 of platen 210 by a dimension corresponding to the second clearance B so that when stopper 248 engages cooking surface 102, flat surface 215 of bottom mold shell 214 is separated from cooking surface 102 by the second clearance B. In other embodiments, platen 210 may comprise a stopper projecting from flat surface 215 by a dimension corresponding to second clearance B. In an aspect, lock 205 can be integrated with stopper 248.

In some embodiments, the leverage mechanism 220 may be configured to elastically bias arm 240 and platen 210 away from cooking surface 102. In some embodiments, leverage mechanism 220 may comprise a torsion spring wrapped around first end 241 of arm 240 to bias arm 240 away from cooking surface 102. In some embodiments, leverage mechanism 220 may comprise an axial spring engaging against a portion of rails 245, lateral struts 246, or second end 242 of arm 240 to bias arm 240 away from cooking surface 102. In some embodiments, leverage mechanism 220 may comprise a hydraulic unit (e.g., piston, dashpot) to bias arm 240 away from cooking surface 102.

In some embodiments, when lock 205 initially releases platen 210, leverage mechanism 220 may be configured to bias arm 240 with platen 210 from the press position to a release position, wherein at least a portion of platen 210 is spatially separated from cooking surface 102 by a third clearance C that is greater than second clearance B and less than first clearance A. In some embodiments, when set at the release position, platen 210 may be disposed at a level below the open position but above the open position. Once set at the release position, a user may move platen 210 to the open position by pivoting arm 240 about hinge 230, thereby providing access to the cooking surface 102, along with the molded food items.

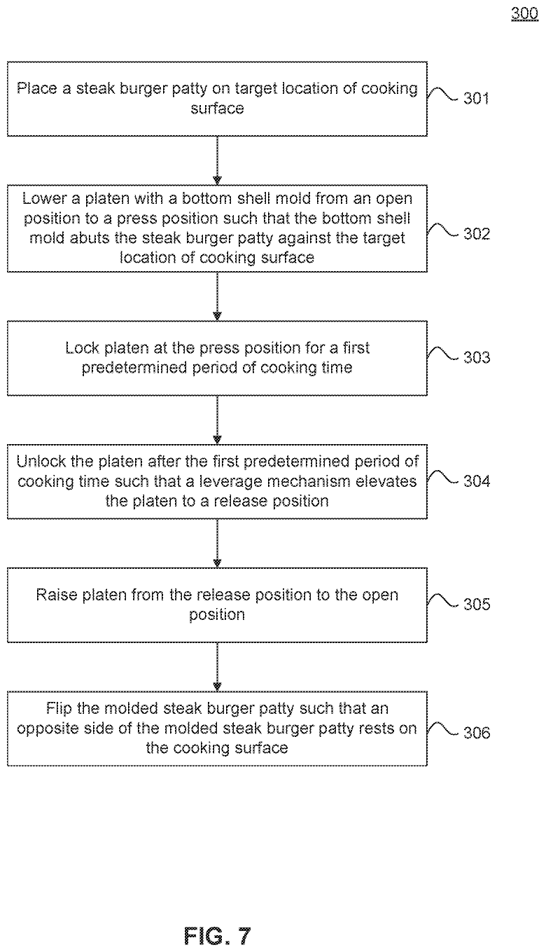

FIG. 7 illustrates an example method 300 for cooking a steak burger according to an embodiment.

In some embodiments, method 300 may comprise a step 301 of placing a raw steak burger puck on target location 120 of cooking surface 102. In an aspect, the steak burger puck can be a sirloin steak burger and can comprise approximately 80% sirloin and approximately 20% choice cuts of meat. The raw steak burger puck can be approximately 2.5 inches to approximately 3 inches in diameter and approximately 1 inch thick. In some embodiments, step 301 may include placing multiple steak burger pucks at target locations 120 of cooking surface 102. For example, step 301 can include placing two, three, four, or more than four steak burger pucks at respective target locations 120 of cooking surface 102. In some embodiments, step 301 may include setting platen 210 at the open position, wherein at least a portion of platen 210 is separated from cooking surface 102 by first clearance A.

In some embodiments, method 300 may comprise a step 302 of lowering platen 210 from the open position to the press position such that bottom mold shell 214 abuts the steak burger puck against target location 120 of cooking surface 102. In some embodiments, step 302 may comprise pivoting arm 240 about hinge 230 to move platen 210 from open position to press position, wherein at least a portion of platen 210 is separated from cooking surface 102 by second clearance B that is less than first clearance A. In some embodiments, step 302 may include receiving the steak burger puck in cavity 217 of bottom mold shell 214 and engaging the steak burger puck against indented surface 216 to mold the steak burger puck into a formed steak burger patty.

In some embodiments, method 300 may comprise a step 303 of locking platen 210 at the press position for a first predetermined period of cooking time (e.g., press time). For example, the predetermined period of cooking time can be approximately 5 seconds. In some embodiments, step 303 may comprise a step of actuating lock 205 to a lock state to retain platen 210 at the press position. In some embodiments, step 303 may comprise displaying the time remaining of the first predetermined period of cooking time. In some embodiments, at step 303, method 300 may include heating the temperature of the bottom mold shell 214 to an operating temperature. In some embodiments, the operating temperature may range from about 110° F. to about 200° F., such as about 140° F. to about 165° F., such as about 140° F. to about 145° F. In some embodiments, step 303 may include flipping the formed steak burger patty.

In some embodiments, method 300 may comprise a step 304 of unlocking platen 210 after the first predetermined period of cooking time such that leverage mechanism 220 elevates platen 210 to the release position. In some embodiments, step 304 may include actuating lock 205 from a lock state to a release state such that lock 205 is decoupled from platen 210 or leverage mechanism 220. After the completion of step 305, the steak burger patty is molded to a formed shape, in which a central portion of the formed steak burger patty comprises a first height and a peripheral portion of the formed steak burger patty comprises a second height that is less than the first height. After the completion of step 305, the steak burger patty is formed and can then be cooked to include crispy, lacey edges and a juicy center.

In some embodiments, method 300 may comprise a step 305 of raising platen 210 from the release position to the open position. In some embodiments, step 306 may comprise pivoting arm 240 about hinge 230 of leverage mechanism 220 to move platen 210 from the release position to the open position.

In some embodiments, method 300 may comprise a step 306 of flipping the formed steak burger patty such that an opposite side of the formed steak burger patty rests on cooking surface 102. In some embodiments, after completion of the completion of step 307, the method 300 may include cooking the formed steak burger patty for a second predetermined period of cooking time. For example, the second predetermined period of time can be approximately 20 seconds to approximately 25 seconds.

In other embodiments, after the completion of step 306, method 300 may include a step of removing the formed steak burger patty without cooking the molded steak burger patty for a second predetermined period of cooking time.

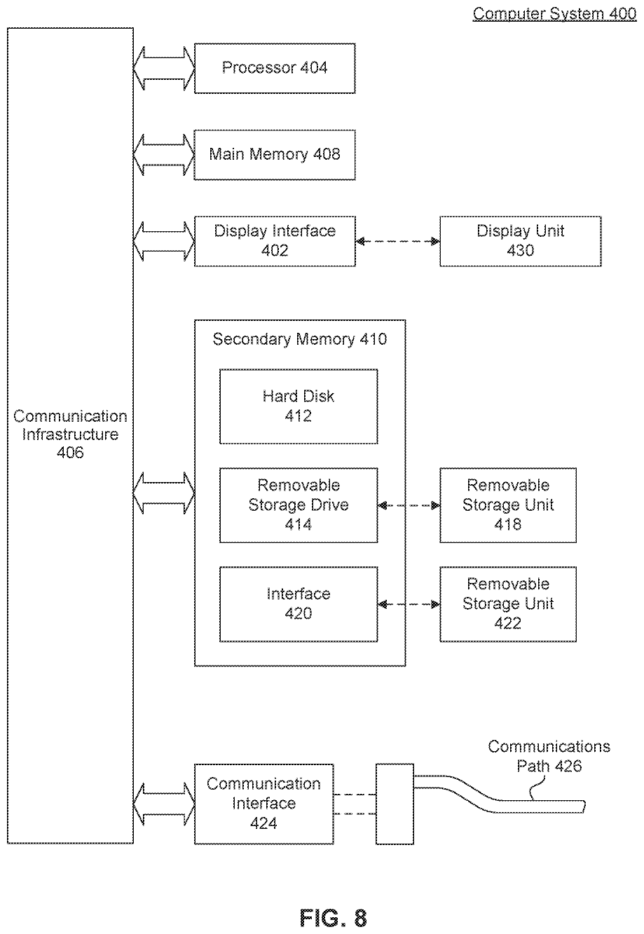

FIG. 8 illustrates an exemplary computer system 400 in which embodiments, or portions thereof, may be implemented as computer-readable code. Timer controller 270 as discussed herein may be computer systems having all or some of the components of computer system 400 for implementing processes discussed herein.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention(s) may be implemented in terms of this example computer system 400. After reading this description, it will become apparent to a person skilled in the relevant art how to implement one or more of the invention(s) using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 404 may be a special purpose or a general purpose processor device. As will be appreciated by persons skilled in the relevant art, processor device 404 may also be a single processor in a multi-core/multiprocessor system, such system operating alone, or in a cluster of computing devices operating in a cluster or server farm. Processor device 404 is connected to a communication infrastructure 406, for example, a bus, message queue, network, or multi-core message-passing scheme.

Computer system 400 also includes a main memory 408, for example, random access memory (RAM), and may also include a secondary memory 410. Secondary memory 410 may include, for example, a hard disk drive 412, or removable storage drive 414. Removable storage drive 414 may include a floppy disk drive, a magnetic tape drive, an optical disk drive, a flash memory, or the like. The removable storage drive 414 reads from and/or writes to a removable storage unit 418 in a well-known manner. Removable storage unit 418 may include a floppy disk, magnetic tape, optical disk, a universal serial bus (USB) drive, etc. which is read by and written to by removable storage drive 414. As will be appreciated by persons skilled in the relevant art, removable storage unit 418 includes a computer usable storage medium having stored therein computer software and/or data.

Computer system 400 (optionally) includes a display interface 402 (which can include input and output devices such as keyboards, mice, etc.) that forwards graphics, text, and other data from communication infrastructure 406 (or from a frame buffer not shown).

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communication interface 424. Communication interface 424 allows software and data to be transferred between computer system 400 and external devices. Communication interface 424 may include a modem, a network interface (such as an Ethernet card), a communication port, a PCMCIA slot and card, or the like. Software and data transferred via communication interface 424 may be in the form of signals, which may be electronic, electromagnetic, optical, or other signals capable of being received by communication interface 424. These signals may be provided to communication interface 424 via a communication path 426. Communication path 426 carries signals and may be implemented using wire or cable, fiber optics, a phone line, a cellular phone link, an RF link or other communication channels.

In this document, the terms “computer program medium” and “computer usable medium” are used to generally refer to media such as removable storage unit 418, removable storage unit 422, and a hard disk installed in hard disk drive 412. Computer program medium and computer usable medium may also refer to memories, such as main memory 408 and secondary memory 410, which may be memory semiconductors (e.g., DRAMs, etc.).

Computer programs (also called computer control logic) are stored in main memory 408 and/or secondary memory 410. Computer programs may also be received via communication interface 424. Such computer programs, when executed, enable computer system 400 to implement the embodiments as discussed herein. In particular, the computer programs, when executed, enable processor device 404 to implement the processes of the embodiments discussed here. Accordingly, such computer programs represent controllers of the computer system 400. Where the embodiments are implemented using software, the software may be stored in a computer program product and loaded into computer system 400 using removable storage drive 414, interface 420, and hard disk drive 412, or communication interface 424.

Embodiments of the invention(s) also may be directed to computer program products comprising software stored on any computer useable medium. Such software, when executed in one or more data processing device, causes a data processing device(s) to operate as described herein. Embodiments of the invention(s) may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

It is to be appreciated that the Detailed Description section, and not the Brief Summary and Abstract sections, is intended to be used to interpret the claims. The Summary and Abstract sections may set forth one or more but not all exemplary embodiments of watercraft carriers as contemplated by the inventors, and thus, are not intended to limit the present embodiments and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A method for cooking a steak burger, the method comprising:
heating the platen;
placing a steak burger puck on a target location indicium formed on a flat cook top;
lowering a press mechanism to mold the steak burger puck into a formed steak burger patty, the press mechanism including:
an arm connected to a hinge, the hinge being attached to the cook top, and
a platen connected to the arm, the platen comprising a concave surface to receive the steak burger puck such that an apex of the concave surface aligns along a vertical axis with the target location indicium;
raising the press mechanism away from the formed steak burger patty; and
removing the formed steak burger patty from the cook top.

2. The method of claim 1, further comprising:
placing a second steak burger puck on a second target location indicium formed on the flat cook top,
wherein the lowering the press mechanism includes molding the second steak burger puck into a second formed steak burger patty.

3. The method of claim 1, wherein the steak burger puck comprises approximately 80% sirloin.

4. The method of claim 1, wherein the target location indicium is stamped or engraved into the cooktop.

5. The method of claim 1, wherein the heating the platen includes heating the platen to a platen temperature of less than approximately 200 degrees Fahrenheit.

6. The method of claim 1, further comprising:
locking the press mechanism in a press position to mold the steak burger puck into the formed steak burger patty; and
automatically releasing the press mechanism from the press position after a press time.

7. The method of claim 1, wherein the formed steak burger patty has a different shape than the steak burger puck.
